(19) United States
(12) Patent Application Publication
(10) Pub. No.: US 2014/0108115 A1
(43) Pub. Date: Apr. 17, 2014

(54) Mobile Satisfaction Monitor

(71) Applicant: Foresee Results, Inc., Ann Arbor, MI (US)

(72) Inventors: Alexei R. White, Vancouver (CA); Mitchell Cohen, Ann Arbor, MI (US); Michael Han, Vancouver (CA); Ho Yan Leung, Vancouver (CA)

(21) Appl. No.: 14/054,093

(22) Filed: Oct. 15, 2013

Related U.S. Application Data
(60) Provisional application No. 61/713,326, filed on Oct. 12, 2012.

(51) Int. Cl. G06Q 30/02; H04W 4/02

(52) U.S. Cl. CPC G06Q 30/0217; H04W 4/028
USPC 705/14.19

(57) ABSTRACT

A method of conducting a survey on a portable device includes obtaining registration information and determining one of at least: (i) a GPS location, (ii) time at the GPS location, (iii) duration at the GPS location; (iii) or frequency at the GPS location. The method further includes invoking a survey on the portable device in response to a trigger, wherein the trigger is in response to the determining one of at least: (i) the GPS location, (ii) time at the GPS location, (iii) duration at the GPS location; (iii) or frequency at the GPS location, and providing an incentive to participate in the survey.

### RELATED APPLICATIONS

This application claims priority to and all advantages of U.S. Provisional Patent Application No. 61/713,326, which was filed on Oct. 12, 2012.

### FIELD OF THE INVENTION

This disclosure generally relates to methods and systems of determining customer satisfaction, and more particularly to conducting surveys on mobile devices.

### BACKGROUND

The desire to improve quality has spread to nearly all manufacturing and service industries, business and social organizations and government. Today, there is great interest in improving quality of products, services, and the environment through systematic performance evaluation followed by business process improvement. Having easily quantifiable metrics to measure the quality of products and services provides a very valuable tool to an industry. These metrics can help facilitate immediate and continuous improvement of products and services.

Further, users of these products and services would benefit from analytical tools that provide ratings of these products and services. Indeed, individuals frequently make decisions based on recommendations of others. In the age of the internet, community opinion is becoming increasingly important.

The best time and place to harvest the experience of a product or service is right there and then. That is because by the time one would log on to a terminal at home, much of the experience may be forgotten. The advent of portable terminals (i.e., smart phones) provides a unique opportunity to interact with the user while the experience with the product or service is still very fresh. Although survey tools currently exist, they generally don't provide a mobile application that provides feedback information on products and services based on location with panel-like research services.

FIG. 1 illustrates the “Yelp” model of rating business and other locations with a simple Likert-scale star rating along with a comment. The results are later shared with their users. This provides a general understanding of a typical client interface.

FIG. 2 illustrates the “Google Places” interface for product and service ratings. FIG. 2 indicates that “Yelp” is limited in scope in that it only provides ratings on restaurants and bars. Further, only a simple rating comment are provided by the users. Accordingly, a detailed analysis is not possible. In this regard, “Google Places” is both an aggregator and a competitor with Yelp with over 50 million business and non-business place entries. Again, “Google Places” merely provides basic reviews from users.

There are several other applications for mobile phones similar to Yelp that relate to providing recommendations on products and services. For example, FIG. 3 illustrates yet another application, known as “TellMeWhere.” Further, FIG. 4 illustrates “CitySearch” which provides a similar service to “Yelp” but with a different user interface.

“Tupalo” (illustrated in FIG. 5) offers yet another variation of an application for a mobile phone that provides recommendations on products and services. “Tupalo” is mainly intended for use in Europe. It is different from Yelp in that it provides some achievement model to entice people to submit content. “GraffitiGeo” (illustrated in FIG. 6) is similar to “Tupalo.” However, it encourage users mainly to either “Like” or “Dislike” locations, thereby lacking sophisticated rating analytical capability.

In view of the foregoing, it would be desirable to have a method and system for a location aware mobile application system that provides reliable information on products and services based on panel driven research services.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates the “Yelp” model of rating business of the prior art.

FIG. 2 illustrates the “Google Places” interface for product and service ratings of the prior art.

FIG. 3 Illustrates the “TellMeWhere” interface for product and service ratings of the prior art.

FIG. 4 Illustrates the “CitiSearch” interface for product and service ratings of the prior art.

FIG. 5 Illustrates the “Tupalo” interface for product and service ratings of the prior art.

FIG. 6 Illustrates the “GraffitiGeo” interface for product and service ratings of the prior art.

FIG. 7 illustrates an embodiment of a ForeSee user interface on a mobile device.

FIG. 8 illustrates a ForeSee help screen consistent with an embodiment of the present invention.

FIG. 9 illustrates an embodiment of a notification experience on a portable device.

FIG. 10 illustrates an embodiment of a user interface after the user agrees to participate in a survey.

FIG. 11 illustrates an embodiment of a user interface when the application is reasonably certain where the user has shopped.

FIG. 12 Illustrates an embodiment of a user interface to depict a browse experience.

FIG. 13 Illustrates an embodiment of an email to a user.

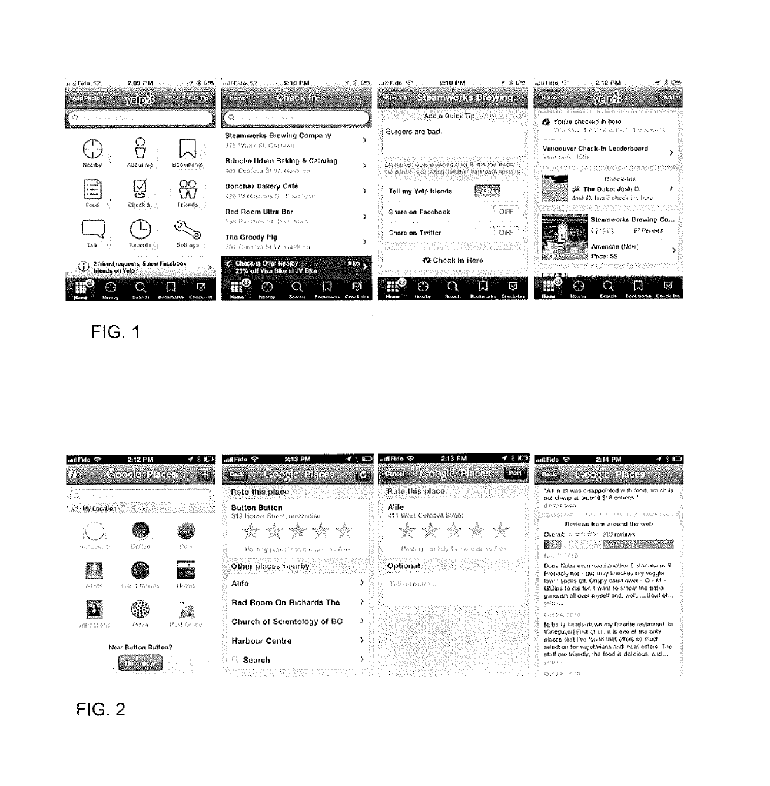

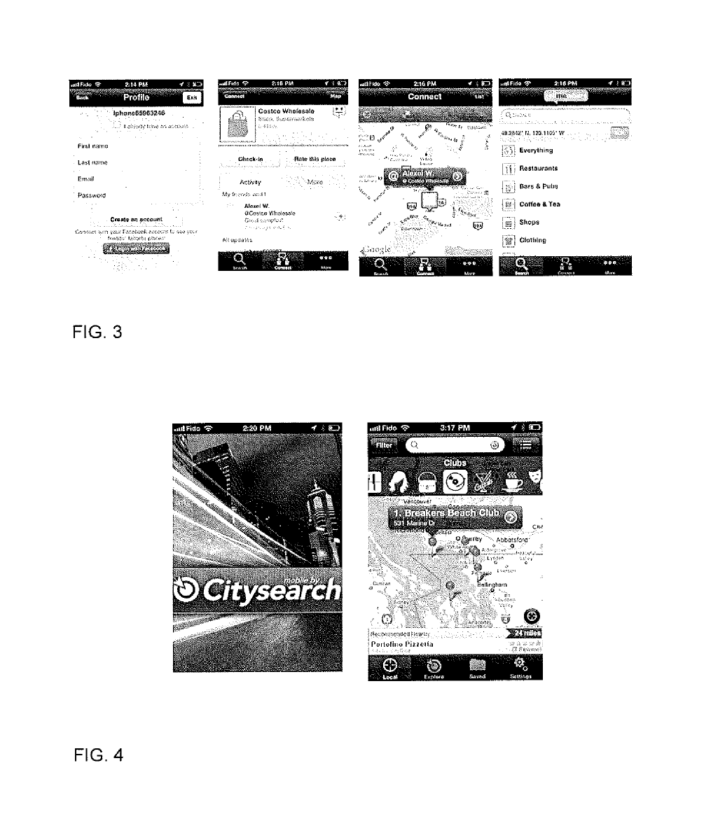

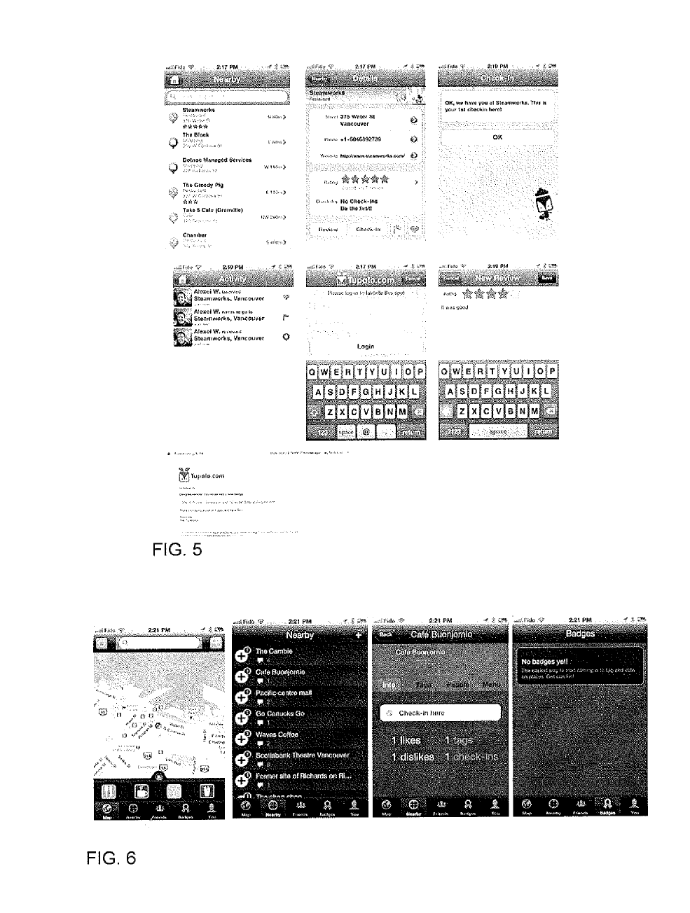

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples described below enable a user to provide their experience with respect to products, services, events, or any venue while the experience is still fresh. In this regard, a mobile device may prompt a user for information based on their location. The application is implemented on any mobile device, including iPhone and Android. As known by one of ordinary skill, each mobile device includes one or more computing devices having at least one non-transitory computer-readable storage medium configured to store one or more executable programs or applications.

Consider for example, a scenario where an individual enters a store to purchase a product. It would be instructive to learn why that individual entered the store, what product they purchased, or why they came out not purchasing any product. If something was purchased, was it because of the price, the convenience, etc.? To the extent nothing was purchased, was it because the store was managed? The price? The floor plan of the store? Such information would be relevant to another user who may be interested in visiting the store or a product therein.

By including an application on the mobile device which has the capability of tracking location, a user could be prompted to respond to a survey related to their experience. For example, the act of leaving a store may trigger the application on the mobile device to prompt the user the following: “we noticed that you just left the store, would you like to provide us some feedback?” The trigger may be based on being at a specific location, the duration of the visit, the time of the visit, or any combination thereof. If the user acknowledges on the user interface of the mobile device (e.g., pressing “o.k.”), then the application launches a survey based on the experience.

Accordingly, the application on the mobile device provides the opportunity to obtain feedback related to a product or service based on their geographic location. This information is of value to both the store and other users. For example, the store may make improvements in order to assure a higher customer satisfaction and increase the likelihood of a sale. As to other users, they may learn from the survey whether that particular store will accommodate their needs.

The mobile survey tool that includes voluntary and ongoing participation of users may combine incentives with an engaging user experience. In this regard, there is an increasing trend of fickleness when it comes to users and mobile applications. In one estimate, 25% of users delete applications after a single use. As users become more experienced, the percentage increases.

The program may be open to anyone. For example, it may be a non-prescreened user group where the centralized server does not know much about the individual participating in the survey. The users may be educated on how the program functions, and the service may gather some basic information about the user.

The data collected could relate to many retail stores, not just current customers. In one embodiment, the ForeSee model may be more of a one-way panel than a social-networking experience. Accordingly to another embodiment, satisfaction data will not be shared with users. However, users may be rewarded with incentives, like gift cards and/or money. In yet another embodiment, there is a website for administering the program. The mobile app would conduct surveys using native controls (not a webview).

In one aspect, clear communication with the user is maintained, with a straightforward, unencumbered user interface. The presentation level is professional, thereby helping communicate a sense of legitimacy and sense of trust. The user will not be bothered more than necessary. For example, information is not asked too often in order not to lose the trust of the user. Long-term participation is more important than frequent-participation because of the inherent cost of acquiring new users.

Applications may contain instructional material to educate users about how the tracking works. Further, there may be instructional material on how the reward system works.

Registration

In one embodiment, initial registration is an option. Registration could be done up front or after points have been collected. For example, a user may be offered the option of registering immediately when they open the app for the first time. When users eventually do full registration, they may be asked to provide basic demographic data (e.g., name, e-mail address, age, gender, etc.).

Incentives

As discussed above, in order to make the feedback process more engaging to the user, there may be an incentive system. The user may be rewarded for participation. In one example, the more they participate, the higher rate of reward they receive. For example, there may be a point system. There may be a point system which can ultimately be redeemed in a variety of ways, including cash, iTunes, Amazon, and other coupons and gift cards.

Accordingly, the user has an incentive to download the mobile app and participate in the surveys to receive certain rewards. In one embodiment, the user has an incentive to download the app for the app itself. Indeed, the app may be coupled with other games and applications that the user may want to download.

Obtaining points is not limited to responding to surveys. For example, a user may gain points by simply being at specific locations at specific times/durations.

Location Tracking

Phones that include a GPS are now ubiquitous. In this regard, the mobile app may use the inherent GPS to infer location. This information may be used to suggest retailers to do surveys for. The app may perform GPS tracking after the app has been closed. Further, the app may suggest appropriate times to perform surveys based on the time and duration of a shopping visit. A user may specify regions where the app should not trigger a survey. For example, the user may choose to specify the areas where they work and live. The user may also turn off the triggering of surveys at specific times (e.g., at night).

Web Presence

A website may be included in the survey system. It may be used to change or look up user account information. It could also be used to obtain information on the program or research the legitimacy of the program. An interface may be provided to join the program.

In one embodiment, the website may provide a means of redeeming reward points. The redemption may be done from a mobile device or a desktop. The website may also provide technical support.

A user may have a choice between filling out a survey on the mobile device or at the website on a desktop. Reminder e-mails could be sent to the users to complete surveys. Again, these surveys could be completed on the mobile device or on a desktop.

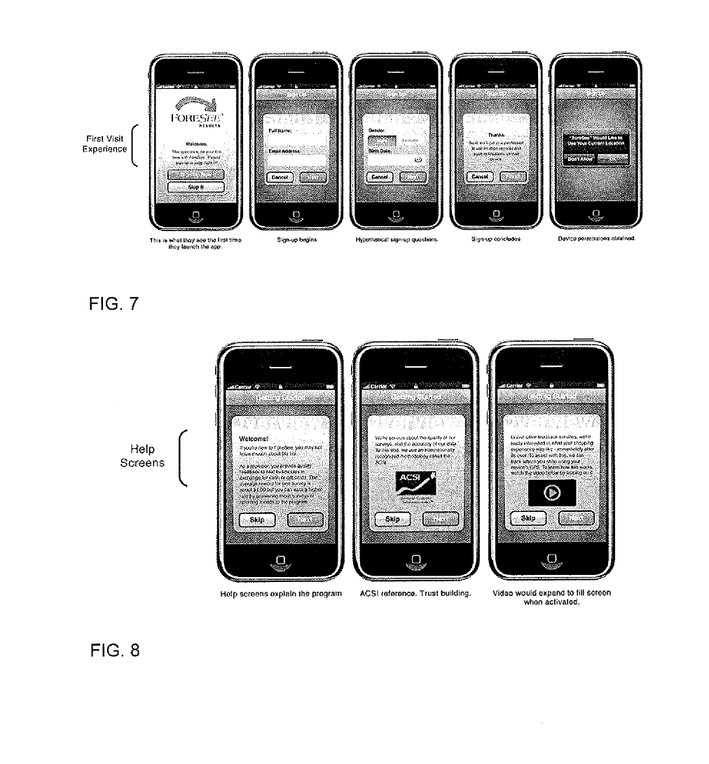

FIG. 7 illustrates one embodiment of a ForeSee user interface on a mobile device. For example, a user may be allowed to skip registration initially. The registration process may collect the relevant demographic data. A username and password may be provided to the user. This will allow the user to access the survey service from another phone or to log in from a web browser. Although the screens illustrated are static, animation may be included as well to make the interface more engaging to the user.

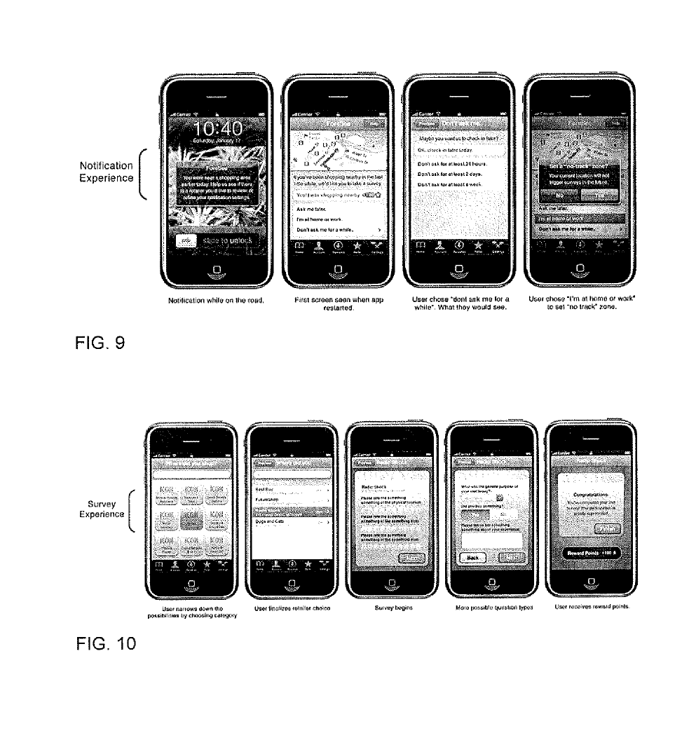

FIGS. 8 and 9 illustrate possible embodiments of a “help screen” interface and a “notification experience” respectively. Different notifications may be provided at different stages. Once a user has signed up and they are being tracked, there may be a push notification in response to a trigger. This trigger may be based on the user's geographic location, the time at a location, the duration of the location, the frequency at a location, or any combination thereof. Once a “push” notification on the mobile device is received, the application on the mobile device is opened. The user may be prompted to respond to a survey. For example, the app may prompt the user on the user interface of the mobile device for some basic information about what they are engaged in. The user can reject, accept, or delay participating in the survey.

On the user interface of the mobile device, the reward points that they will earn may be displayed. For example, the reward points may be indicated on the button that begins the survey, as illustrated in the second iPhone picture of FIG. 9.

FIG. 10 illustrates an embodiment of a user interface once the user agrees to participate in a survey. In this regard, the list of possible locations may be narrowed down such that the user is not overwhelmed. For example, if the user is near a busy commercial district, the list may be long. A user may search by name or choose a category. The category may be narrowed by the app by listing businesses in the vicinity of the GPS path. At the end of the survey, there may be an animated alert, indicating the accumulated reward points.

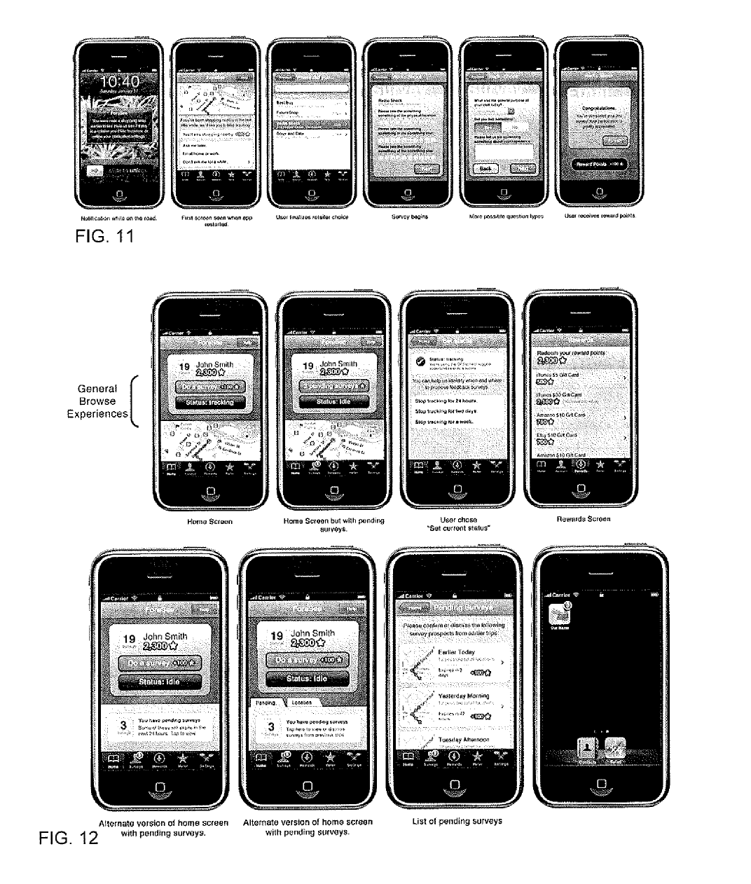

FIG. 11 illustrates an embodiment of a user interface when the application is reasonably certain where the user has shopped. When the list of potential shopping locations is short or the app is reasonably certain where the user is located, the app can jump from the notification to the survey.

FIG. 12 illustrates an embodiment of a user interface to depict a browse experience. When a user launches the app to explore, they may observe a tab bar at the bottom with the following hypothetical categories:

Home—From here a user may start a new survey or set their status. By setting their status a user may tell the app that they're about to go shopping, they are shopping now, or that they won't be shopping for a fixed period of time. They may also see their accumulated reward points at a glance;

Surveys—This screen provides the pending list of surveys. If no list exists, the app provides an opportunity to the user to suggest where they shopped;

Rewards—this is where a user may redeem their reward points;

Refer—here a user may earn points by inviting friends. They may earn the points once the invitees have actually installed the app; and

Settings—Tracking settings, notification settings, etc. The app may be able to provide this tab in the device's settings area under the global iPhone settings. On Android the app may group these settings in the app itself.

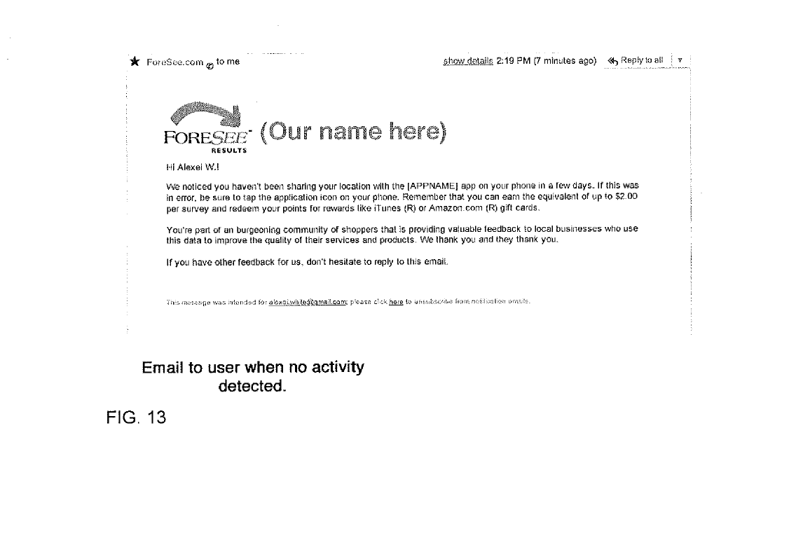

FIG. 13 Illustrates an embodiment of an email to a user. For example there may be some scenarios where the user is e-mailed instead of being notified on their portable device. For example, there may be no GPS updates for a predetermined amount of time with no explanation. Further, pending surveys may be about to expire. Yet another scenario may be that no surveys were completed in a predetermined number of weeks.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

1. A method of conducting a survey on a portable device, the method comprising:
obtaining registration information;
determining one of at least: (i) a GPS location, (ii) time at the GPS location, (iii) duration at the GPS location; (iii) or frequency at the GPS location;
invoking a survey on the portable device in response to a trigger, wherein the trigger is in response to the determining one of at least: (i) the GPS location, (ii) time at the GPS location, (iii) duration at the GPS location; (iii) or frequency at the GPS location; and
providing an incentive to participate in the survey.

2. The method of claim 1 wherein the registration information is obtained after a first point is rewarded.

3. The method of claim 1, further comprising:
inferring a business, store, service or venue from the GPS location; and
suggesting a business, store, service, or venue as a subject of the survey.

4. The method of claim 1, further comprising:
downloading an application on the portable device, wherein the application provides the survey.

5. The method of claim 4, further comprising:
suggesting appropriate times to perform the surveys based on when a user of the portable device has been in a single location for one of at least (i) a predetermined time, (ii) a predetermined duration of time, (iii) or a predetermined frequency, wherein the suggesting is performed by the application.

6. The claim of claim 1, further comprising specifying locations and time where the trigger should not occur.

7. The claim of claim 1, wherein a user participating in the survey earns a higher rate of reward the more they participate.

8. The method of claim 1, further comprising redeeming points earned in the survey at a central web/site.

9. The method of claim 1, further comprising sending a reminder e-mail to a user of the portable device to complete the survey.
